(19) United States
(12) Patent Application Publication
(10) Pub. No.: US 2001/0043285 A1
(43) Pub. Date: Nov. 22, 2001

(54) Video information insertion system

(76) Inventors: Thomas P. Hicks, Lafayette, IN (US); W. Joseph Leonard, Indianapolis, IN (US); Larry R. McMann JR., Lebanon, IN (US)

Correspondence Address: Todd T. Taylor, TAYLOR & AUST, P.C., 142 S. Main St., P.O. Box 560, Avilla, IN, 46710, US

(21) Appl. No.: 09/815,636

(22) Filed: Mar. 23, 2001

Related U.S. Application Data
(60) Provisional application No. 60/193,785, filed on Mar. 31, 2000.

(51) Int. Cl. H04N 9/74; H04N 9/76

(52) U.S. Cl. 348/600; 348/589

(57) ABSTRACT

A technique for displaying advertising messages along the border of a conventional video display without obscuring any of the conventional video display. A video signal is received from a television station, satellite, cable, or video recording device and the effective size of the received video information is reduced so that the received information occupies only a portion of a display device thereby freeing another portion for other use. A locally stored message is introduced to occupy the other portion of the display. The message may, for example comprise one or more advertising banners extending along edges of the received information display. The message provider may sell advertising space to customers and pay the owner of the establishment in which the program and advertising message are displayed a fraction of the advertising revenue. The locally stored message may be periodically updated by the message provider from a remote source by way of a modem or similar communication link.

### CROSS REFERENCE TO RELATED APPLICATIONS

The application is based upon U.S. provisional patent application Ser. No. 60/193,785, entitled “AD-WURKS SYSTEM”, filed Mar. 31, 2000, the complete disclosure of which is hereby expressly incorporated by reference.

### BACKGROUND OF THE INVENTION

1. Field of the Invention

The present invention relates generally to display systems and more particularly to display systems and techniques for introducing messages adjacent displays received from remote sources.

2. Description of the Related Art

Commercial television broadcasts sometimes include public service announcements, for example, weather alerts or school closing notices, for display along the bottom of television receivers. Translations into a second language or closed captioning for the hearing impaired may similarly be displayed. These messages may be fixed, may change periodically, or may move slowly across the bottom of the screen (called “crawlers”). Similarly, other sporting event scores are frequently displayed along the bottom of the receiver screen during sportscasts, and local weather conditions may be displayed along the screen lower edge of national weather presentations. These messages are an integral part of the program transmission. In all cases, the displayed message originates with and is transmitted by the television station (cable or satellite supplier) and typically covers or obscures a portion of the displayed television picture.

Many personal computer programs display so-called task bars or tool bars along the top and/or other edges of the screen. Many of these include pull-down or fly-out menus which, when extended, overly and obscure a portion of the computer display. In some cases, the software provides the user with an option of having the menu obscure part of the underlying display or having the underlying display cover and obscure part of the menu. Again, the menu messages originate from the same source (e.g., computer disk drive) as the displayed program information

All of these messages are somehow related to the other displayed information. The message is either transmitted as an integral part of the television program or the messages are an integral part of the associated computer software. The message and display are either content related as in the case of a computer software, or transmission medium and/or source related as in the case of a television transmission with the message and program originating at the same location and sharing a common carrier. It would be highly desirable to be able to append an unrelated message to a display at other than the point of origin of the display.

### SUMMARY OF THE INVENTION

The present invention provides a process for introducing messages to be displayed with other unrelated visual information without obscuring the visual information.

The invention comprises, in one form thereof, a technique for displaying advertising or other messages in juxtaposition with program information on a visible portion of one or more display devices located in a business establishment of a type providing displays of the program information for customers. The process modifies the program information to occupy less than the entire visible portion of the display device thereby creating an open region and introduces the advertising message into the open region. The advertising message may be periodically changed independently of the displayed program information, for example remotely by way of a modem or other digital link. Advertising revenues may be collected by the remote message supplier and a portion thereof paid to the business establishment for displaying the advertising to clientele.

An advantage of the present invention is that the content of locally stored messages can be changed periodically independent of the displayed program information.

Another advantage of the present invention is that the displayed locally stored messages do not obscure any part of the displayed program information.

A further advantage of the present invention is that no modification of the display device nor of the apparatus for receiving incoming program information is required.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic illustration of a video information insertion system according to the invention in one form;

FIG. 2 is a simplified front view of a television receiver showing received program information or other display occupying the entire visible receiver screen;

FIG. 3 is a simplified front view of a television receiver showing received program information sharing the visible portion of the receiver screen with a message which occupies the right edge of the screen;

FIG. 4 is a simplified front view of a television receiver showing received program information sharing the visible portion of the receiver screen with a message occupying the right edge and bottom edge of the screen;

FIG. 5 is a simplified front view of a television receiver similar to FIG. 4 showing received program information sharing the visible portion of the receiver screen with a smaller message occupying the right edge and bottom edge of the screen;

FIG. 6 is a simplified front view of a television receiver showing received program information sharing the visible portion of the receiver screen with a message surrounding the program information; and

FIG. 7 is a detailed block diagram of the video information insertion device of FIG. 1.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

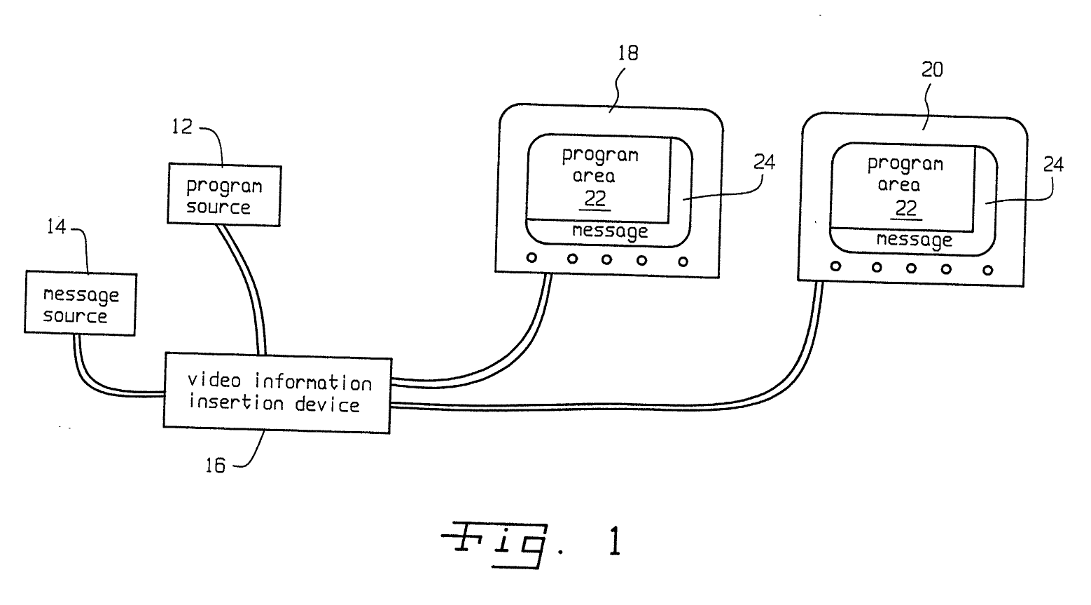

Referring now to the drawings and particularly to FIG. 1, there is shown an illustrative system for displaying messages such as advertising banners juxtaposed with other program displays at a public site such as a restaurant, tavern, airport, or other commercial establishment. A signal source 12, for example, incoming programming from a commercial television station are received and forwarded to the video information insertion device 16. The signal source 12 may be a conventional radio frequency television tuner, a local storage device such as a video recording device, cable television connection, satellite tuner or similar device. Advertising or other messages are received from a remote message source 14, for example, by way of a modem connection, and stored in the insertion device 16. The insertion device 16 reduces the effective display area required by the incoming programming to the display area 22 and introduces an unrelated message into the area 24 of conventional television receivers 18 and 20, or other display devices. As used herein, the terms program information or existing video image are used to distinguish the normal display content typically received by wireless transmission from a satellite or television station, a video recorder, cable TV supplier or closed circuit TV source, from locally generated information or messages which are frequently advertising messages periodically received from a source such as 14 and stored in the insertion device 16. The video information insertion device 16 may reduce the display area 22 required for the program information and create message areas 24 in numerous ways.

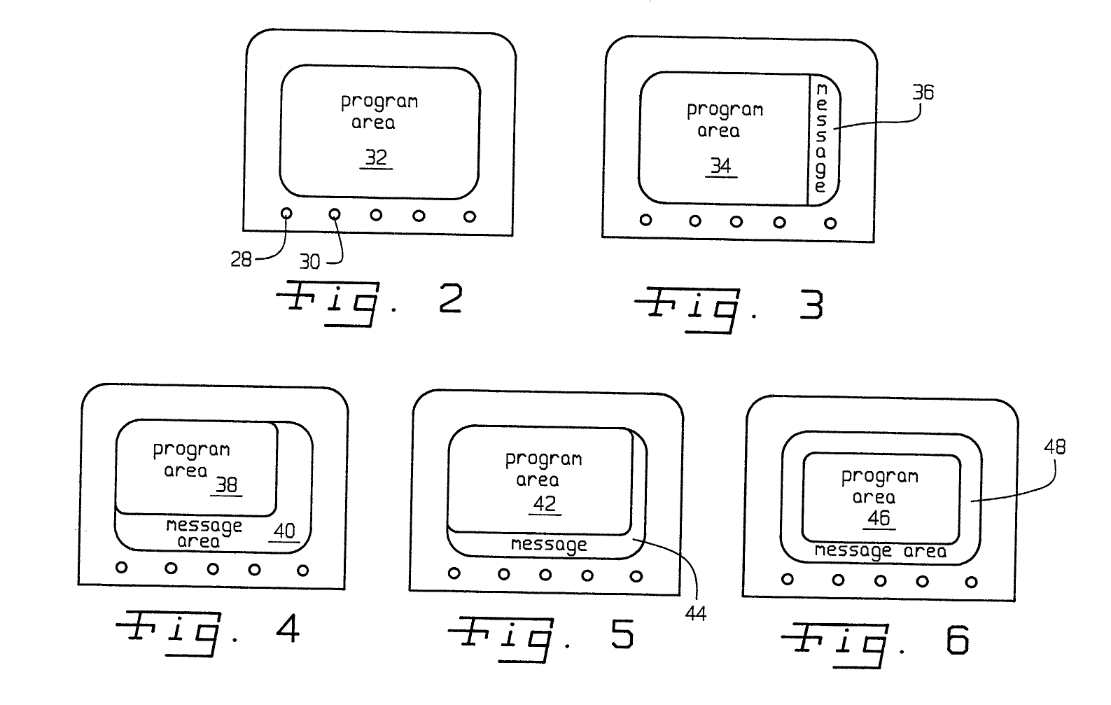

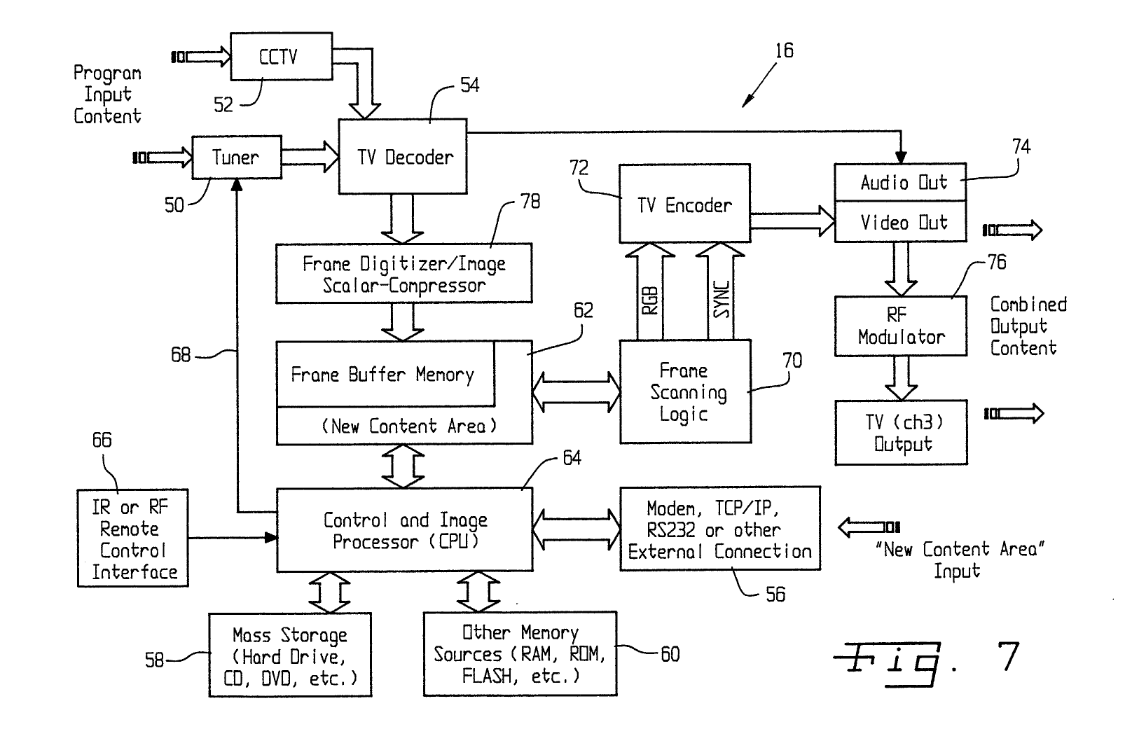

In FIG. 2, a conventional television receiver 26 having typical controls such as volume 28 and tuning 30 has the entire visible area 32 of the display dedicated to the program information. The program information occupies the entire available visible area of the display device. In FIG. 3, the display area 34 for program information is reduced in size, however, the incoming information is not clipped or cropped and essentially everything that was displayed in area 32 is now displayed in area 34, and a portion 36 of the screen is now free for the display of advertising or other messages. In FIG. 3, the message area 36 occupies a vertical strip along one border of the screen, however, the message area may take on a number of other configurations. In FIG. 4, the area required for the incoming programming has been reduced both vertically and horizontally to area 38 providing a message area 40 which extends along both the bottom and right hand edges of the screen. FIG. 5 illustrates a similar subdivision of the display area, however, the program area 42 has increased and the message area 44 shrunk. FIG. 6 illustrates the program area 46 centralized on the screen and surrounded by message space 48 about the entire border. The allocations of the screen area shown in FIGS. 4, 5 and 6 have an advantage over that shown in FIG. 3 in that the aspect ration (the ration of picture width to height) may be maintained unchanged. Comparing FIGS. 4 and 5, FIG. 4 emphasizes the message area and is more likely to draw the viewer's attention to that message while the message of FIG. 5 may distract the viewer less from the program content. The particular choice may be influenced by these and other considerations. Numerous other allocations of the visible display area between program and message areas are possible.

A more detailed illustration of the video information insertion device 16 is shown in FIG. 7. Device 16 may be used to create and utilize a frame of advertising or other content about an existing video image. The image displayed on the program area may contain still or moving information and may include local CCTV, broadcast TV, satellite and/or cable programming, security images and other forms of content. The image content or program information is reduced in size from its normal “full-screen” leaving an image free region on either the top, bottom, left or right, or some combination thereof as illustrated by FIGS. 2-6. This free region is now available for additional appropriate content information such as local news, weather, advertising, bulletins and special offerings. Thus, the user may display additional information such as advertising without changing, disrupting, distorting or obscuring the program information in any way. The system may utilize a direct or remote method of selecting the input program material, e.g., selecting a broadcast or cable TV station via tuner 50 or a closed circuit TV signal via the CCTV input 52. The demodulated (or unmodulated) signal is supplied to TV decoder 54. Decoder 54 separates the audio and video signal components and further separates the video component into the image and synchronization components. These signals are digitally organized and placed into the frame buffer 62. The frame digitizer/image scalar-compressor 78 has the ability to reduce the image through either a loss or loss-less technique. The image is placed into the frame buffer in such a way as to allow for a new content area. The new content area is loaded periodically in either a sequential or pseudo-random fashion from either mass storage source 58 or other memory 60 by the control and image processor 64. The control and image processor or CPU has the responsibility of selecting and manipulating the new content area (containing, for example, an advertising message) of the frame buffer 62 as well as selecting the incoming program content source, for example, as dictated by remote control input to the interface 66 and commands issued on line 68. The CPU 64 also receives and stores new content area information, display timing and format instructions through an external connection such as the modem 56. The frame buffer information is played back in real time by the frame scanning logic 70. This logic section is responsible for scanning the frame buffer memory 62 including the new content area and reconstructing a video, e.g., color RGB signal as well as synchronization signals. These signals are combined to form a nominal TV signal by the TV encoder 72. In one implementation, encoder 72 was a Rockwell Bt868/Bt869 video encoder. The audio portion of the signal is unaltered and is reintroduced at 74, and the combined signal may be used to modulate a carrier at 76 for transmission to conventional TV receivers, or the video may be sent directly to monitors as desired.

The system may utilize a direct or remote method for controlling the positions and contents of the inserted message regions. This may be accomplished by a hard, wired or wireless arrangement, e.g., modem, TCP/IP or RS232 port as illustrated at 56. The inserted content or message may be stored on a mass 58 or other memory 60 and may be recalled pseudo-randomly or in sequence depending on the desired total viewing effect. Once the inserted content or message has framed the incoming or program information, the combined image is reproduced as a TV compatible image where it may be viewed on a standard TV receiver such as 18, or a monitor.

In operation, advertising messages are displayed in juxtaposition with program information on a visible portion of a display device located in a business establishment, for example, of the type providing displays of the program information for customers by modifying the program information to occupy less than the entire visible portion of the display device thereby creating an open region and introducing an advertising message into the open region. The advertising message is periodically changed independently of the displayed program information. Preferably, the open region comprises about fifteen percent of the visible portion of the display device. There may be a plurality of additional business establishments at locations separated from one another with at least one display device located at each business location to provide displays of program information some of which is unrelated to the program information displayed at other of the business locations. Program information at each additional business location would be modified to occupy less than the entire visible portion of the associated display device thereby creating an open region in the visible portion of each display device even though the program information differed from establishment to establishment. An advertising message would be inserted into each open region and periodically changed independently of the displayed program information, for example, by transmitting new advertising messages from a source remote from each of the business establishment locations and from the program source locations. Typically separate individual entities own the business establishments and a further separate individual business entity owns the remote advertising source and advertising revenues are collected by the further separate entity and an amount totaling less than the advertising revenues is paid by the further separate entity to each of the separate individual and the advertising messages are stored at the business establishment.

In one form, transmitted program information such as conventionally broadcast television is received and demodulated, and the demodulated signal is separated into audio and video portions. The synchronization information is removed from the video portion and the video portion converted to a digital form for combination with an advertising message. The combined video portion digital form and advertising message may be reconverted to an analog form and recombining with the unaltered audio portion and superimposed on a radio frequency carrier for transmission to a plurality of conventional television receivers.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of displaying advertising messages in juxtaposition with program information on a visible portion of a display device located in a business establishment which provides displays of the program information for customers, comprising the steps of:
modifying the program information to occupy less than the entire visible portion of the display device thereby creating an open region;
introducing an advertising message into the open region; and
periodically changing the advertising message independently of the displayed program information.

2. The method of claim 1, wherein the open region comprises about fifteen percent of the visible portion of the display device.

3. The method of claim 1, wherein there are a plurality of additional business establishments at locations separated from one another and from said business establishment location, and wherein there is at least one display device located at each additional location which provides displays of program information some of which is unrelated to the program information displayed at said business location, the method including the additional steps of:
modifying the program information at each additional business location to occupy less than the entire visible portion of the associated display device thereby creating an open region in the visible portion of each display device;
introducing an advertising message into each open region; and
periodically changing the advertising message independently of the displayed program information.

4. The method of claim 3, wherein the step of periodically changing comprises transmitting new advertising messages from a source remote from each of the business establishment locations and from the program source locations.

5. The method of claim 3, wherein separate individual entities own the business establishments and a further separate individual business entity owns the remote advertising source, advertising revenues being collected by the further separate entity and an amount totaling less than the advertising revenues is paid by the further separate entity to each of the separate individual entities for displaying the advertising to their respective customers.

6. The method of claim 1, wherein the program information includes an audio portion which is unaffected by the step of modifying.

7. The method of claim 1, wherein the program information is transmitted to the business establishment location from a program source remote from the business establishment location and the advertising messages are stored at the business establishment.

8. The method of claim 7, wherein the step of modifying comprises:
receiving the transmitted program information;
demodulating the received signal:
separating the demodulated signal into audio and video portions;
removing the synchronization information from the video portion;
converting the removed video portion to a digital form;
combining the video portion digital form with an advertising message;
converting the combined video portion digital form and advertising message to an analog form;
recombining the audio portion and converted analog form; and
superimposing the recombined portions on a radio frequency carrier for transmission to a plurality of conventional television receivers.

9. The method of claim 7, wherein the step of periodically changing comprises transmitting new advertising messages from a source remote from both the business establishment location and the program source location.

10. The method of claim 1, wherein the program information is stored on and played from a first storage device and the advertising messages are stored and played from a second storage device distinct from the first storage device and both storage devices are located at the business establishment.

11. The method of claim 10, wherein the step of periodically changing includes transmitting new advertising messages from a source remote from both the business establishment location

12. The method of claim 1, wherein a first entity owns the business establishment and a second distinct business entity owns the remote advertising source, advertising revenues being collected by the second entity and an amount less than the advertising revenues is paid by the second entity to the first entity for displaying the advertising to its customers.

13. A method of displaying locally stored information as part of a received television transmission, comprising the steps of:
demodulating the received signal;
reducing the effective display area required by the received video portion of the transmission to occupy less than the entire visible display area of a display device and thereby free-up a display device region adjacent a border of the visible display area;
introducing the locally stored information into the video signal to occupy the freed-up region.

14. The method of claim 13, wherein the step of reducing comprises:
separating the demodulated signal into audio and video portions;
removing the synchronization information from the video portion; and
converting the removed video portion to a digital form.

15. The method of claim 14, wherein the step of introducing comprises:
combining the video portion digital form with an advertising message;
converting the combined video portion digital form and advertising message to an analog form;
recombining the audio portion and converted analog form; and
superimposing the recombined portions on a radio frequency carrier for transmission to a plurality of conventional television receivers.

16. A method of appending a message to previously created program information for presentation on a display device to clientele at a business establishment, comprising the steps of:
modifying the program information to occupy less than the entire visible portion of the display device thereby creating an open region;
introducing an advertising message into the open region; and
periodically changing the advertising message independently of the displayed program information.

17. The method of claim 16, wherein the wherein the message content is unrelated to the information being displayed.

18. The method of claim 16, wherein a first entity owns the business establishment, and further comprising an advertising source remote from the business establishment from which messages originate, the remote advertising source being owned by a second distinct business entity, advertising revenues being collected by the second entity and an amount less than the advertising revenues is paid by the second entity to the first entity for displaying the advertising to its clientele.

19. The method of claim 16, wherein the step of periodically changing the advertising message includes periodically transmitting messages to the business establishment location from a program source remote from the business establishment location, and storing the advertising message at the business establishment.
